(19) United States
(12) Patent Application Publication
(10) Pub. No.: US 2009/0032457 A1
(43) Pub. Date: Feb. 5, 2009

(54) Hydrocyclones

(76) Inventor: Oscar Castro Soto, Santiago (CL)

Correspondence Address: JULIE K. MORRISS;MORRIS O'BRYANT COMPAGNI, PC, 734 EAST 200 SOUTH, SALT LAKE CITY, UT, 84102, US

(21) Appl. No.: 11/990,369

(22) PCT Filed: Aug. 1, 2006
(86) PCT No.: PCT/AU2006/001087

§ 371 Date: May 14, 2008

(30) Foreign Application Priority Data
Aug. 12, 2005 (AU) 2005904368

(51) Int. Cl. B04C 3/06

(52) U.S. Cl. 210/512.1

(57) ABSTRACT

An inlet head for a cyclone, the inlet head including a feed chamber therein having an inner side wall, a top or end wall at one end of the side wall, an open end at the other end of the side wall, the open end being of circular cross-section with a central axis, an inlet port adjacent the top or end wall for delivering an inlet stream of material to be separated to the feed chamber, an overflow outlet in the top or end wall which is coaxial with the central axis, a vortex finder extending into the feed chamber in the direction of the central axis through which an overflow stream of separated material passes to the overflow outlet. The vortex finder includes a generally tubular body having a side wall with an outer side wall surface and a passageway which includes an inlet end and an outlet end the passageway extending through the body, the passageway having an inner side wall surface and an end face at the inlet end wherein the end face is generally annular shaped and is curved from the inner wall surface outwardly towards the outer side wall surface and towards the other end.

This invention relates generally to cyclone separators for separating or classifying materials and components therefor. In one particular preferred application, the present invention is concerned with hydrocyclones for separating or classifying slurries in the mineral processing industry

Hydrocyclones generally comprise a vessel having a central longitudinal axis and which includes an inlet head, having a feed chamber therein with an inner side wall and an end wall, an inlet port for delivery of a slurry containing material to be separated to the feed chamber, an overflow outlet in the end wall and a vortex finder which extends in the direction of the longitudinal axis into the feed chamber and is connected to the overflow outlet. The hydrocyclone further includes a separating section downstream of the inlet head which has a separating chamber with a conically shaped inner wall, and a tubular under flow outlet at the end of the separating section.

An important hydrocyclone operating measurement used in the industry for comparing the relative performance of hydrocyclones is the “d50 cut size”. This term refers to the particle size where 50% of that particle size separates to the underflow stream due to the action of the hydrocyclone. For example a “d50 cut size=0.024” indicates that 50% of the 0.024 mm sized particles separates to the underflow stream. In a similar manner it can be said the hydrocyclone centrifugal efficiency of the 0.024 mm particles is 50%.

With very small particles, say 0.001 mm sized particles it would be expected that all would be directed to the overflow outlet and as such the hydrocyclone has 100% efficiency to the overflow, for such particles. In practice, however, this is not the case. The very small particles tend to be directed to the overflow outlet and underflow outlet in approximately the same proportion as the water split. This is because the hydrocyclone itself does not act on some of these very small particles. Large particles, say 2.0 mm sized particles, can be said to have 100% efficiency to the underflow, because every particle of this size separates to the underflow stream.

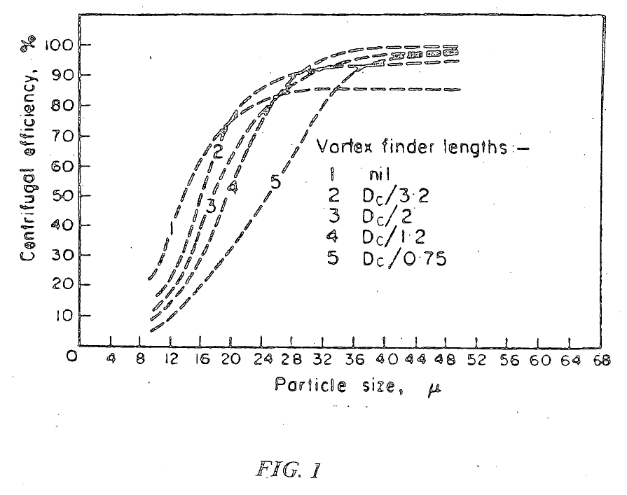

FIG. 1 is a graph taken from the reference “The Hydrocyclone” by D Bradley which illustrates the effect of vortex finder length on centrifugal efficiency and “d50 cut size”. The centrifugal efficiency is a measure of the particles which are recovered to the underflow outlet.

Plotting the centrifugal efficiency of each particle size present in the slurry results in a typical “S”-shaped efficiency curve for the hydrocyclone under consideration and the 50% point plotted on the curve corresponds to the “d50 cut size”. A common goal in hydrocyclone development is to reduce the “d50 cut size”, by shifting the “S”-curve to the left, while obtaining the same or an improved “S” shaped efficiency curve which defines the hydrocylone's relative performance.

It can be seen from the graph that the effect of shortening the vortex finder length expressed as a ratio of the hydrocyclone feed chamber diameter Dc in each case, produces a corresponding set of “S” shaped performance curves numbered 1-5. Preferred features of the “S”-curve for a hydrocyclone sought by designers are to have a steep slope as in curve No2 but retain top end performance as in curve 4 which minimises the amount of coarse particles moving past the vortex finder and into the overflow stream.

It can be seen that “S”-curve No2, representing a very short vortex finder length, is steeper at the d50 cut size and therefore centrifugal efficiency is very good at this point of the curve. However curve No2 has the undesirable behavior of flattening out at the top end at lower centrifugal efficiency compared to curves 3 and 4 which flatten out at higher centrifugal efficiency. The poor top end performance of curve 2 gives unwanted coarse particles in the overflow stream and is the primary reason short vortex finders are not used in industry. These tests were developed with hydrocyclones with standard inlet heads. A further development of an inlet head is described in International Patent Specification WO 2005/021162 (PCT/AU2004/001152) in the name of Weir Warman Ltd. The commercial form of the inlet which is subject of the aforementioned patent specification is sold under the trade mark CAVEX whish is a trade mark of Weir Warman Ltd.

According to one aspect of the present invention there is provided an inlet head for a cyclone, the inlet head including a feed chamber therein having an inner side wall, a top or end wall at one end of the side wall, an open end at the other end of the side wall, the open end being of circular cross-section with a central axis, an inlet port adjacent the top or end wall for delivering an inlet stream of material to be separated to the feed chamber, an overflow outlet in the top or end wall which is coaxial with the central axis, a vortex finder extending into the feed chamber in the direction of the central axis through which an overflow stream of separated material passes to the overflow outlet, the vortex finder having a free end portion which is configured so for a vortex finder of selected length the hydrocyclone efficiency is increased.

Preferably the vortex finder includes a generally tubular body having a side wall with an outer side wall surface and a passageway extending through the body, the passageway having an inner side wall surface and an end face at the free end portion.

According to another aspect of the present invention there is provided an inlet head for a cyclone, the inlet head including a feed chamber therein having an inner side wall, a top or end wall at one end of the side wall, an open end at the other end of the side wall, the open end being of circular cross-section with a central axis, an inlet port adjacent the top or end wall for delivering an inlet stream of material to be separated to the feed chamber, an overflow outlet in the top or end wall which is coaxial with the central axis, a vortex finder extending into the feed chamber in the direction of the central axis through which an overflow stream of separated material passes to the overflow outlet, the vortex finder including a generally tubular body having a side wall with an outer side wall surface and a passageway which includes an inlet end and an outlet end the passageway extending through the body, the passageway having an inner side wall surface and an end face at the inlet end characterised in that the end face is generally annular shaped and is curved from the inner wall surface outwardly towards the outer side wall surface and towards the other end.

In one form the outer side wall surface of the vortex finder has a free edge and the end face may be generally convex in shape when viewed in axial cross section extending beyond the free edge of the outer side wall surface to the inner side wall surface.

In another form the vortex finder may include a flange on the outer side wall section in the region of the end face, the flange including side sections extending from the side wall surface terminating at a distal portion. The side sections of the flange may be curved with one forming the end face. Preferably the flange side sections are generally concave in shape when viewed in axial cross section. The outer side wall surface may include a first section remote from the free end portion and a second section between the first section and the free end portion the second section being of smaller cross sectional dimension than the first section.

The vortex finder is particularly suited for use with an inlet head which includes a feed inlet zone in the inner side-wall of the feed chamber having an upstream end adjacent the inlet port and a downstream end, the feed inlet zone being in the form of a volute having a volute axis extending around the inner side wall and including a first sector in which the volute axis is generally at right angles to the central axis and a second sector in which the volute axis extends around the side wall generally in the direction of the central axis away from the end wall wherein the distance from the volute axis to the central axis decreases with the progression of the volute from the inlet port. Preferably the inlet port has a feed height dimension H1 in the direction of the central axis and the vortex finder extends into the feed chamber in the direction of the central axis at a distance L1 from the top or end wall, the distance L1 being less than the height dimension H1.

The inlet port is preferably generally rectangular in cross-section. The distance L1 is preferably less than 0.95 of the height dimension H1.

The first sector may progress horizontally from the inlet port around the inner side wall for an angle α1 which ranges from 0° to 100°. The second sector preferably descends from the horizontal plane and it extends in the direction of the central axis over a distance D ranging from 0.25×H1 to 1×H1 for every 90° of progress around the inner side wall.

In a preferred form the inlet head is of the type referred to under the trade mark CAVEX as referred to earlier. According to another aspect of the present invention there is provided a hydrocyclone which includes an inlet head as described above, a separating section having an inner side wall which tapers inwardly away from the inlet head, and an underflow outlet at the other end of the separating section remote from the inlet head. Preferably the overflow outlet and underflow outlet are generally axially aligned.

Preferred embodiments of the invention will hereinafter be described with reference to the accompanying drawings and in those drawings.

FIG. 1 is a graph illustrating the effect of vortex finder length on the centrifugal efficiency and cut size, using standard inlet heads;

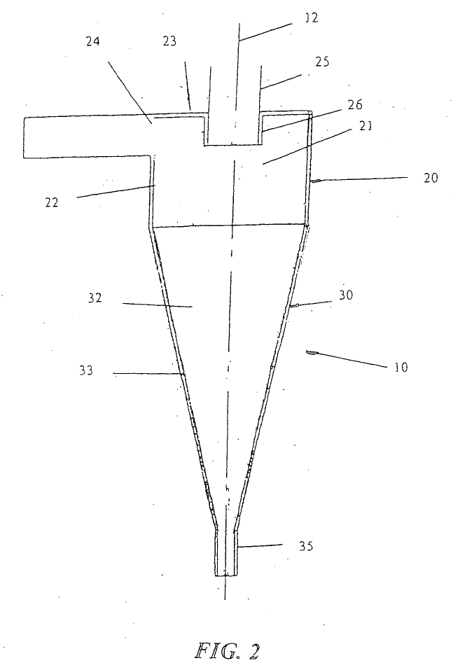

FIG. 2 is a schematic illustration of a typical hydrocyclone;

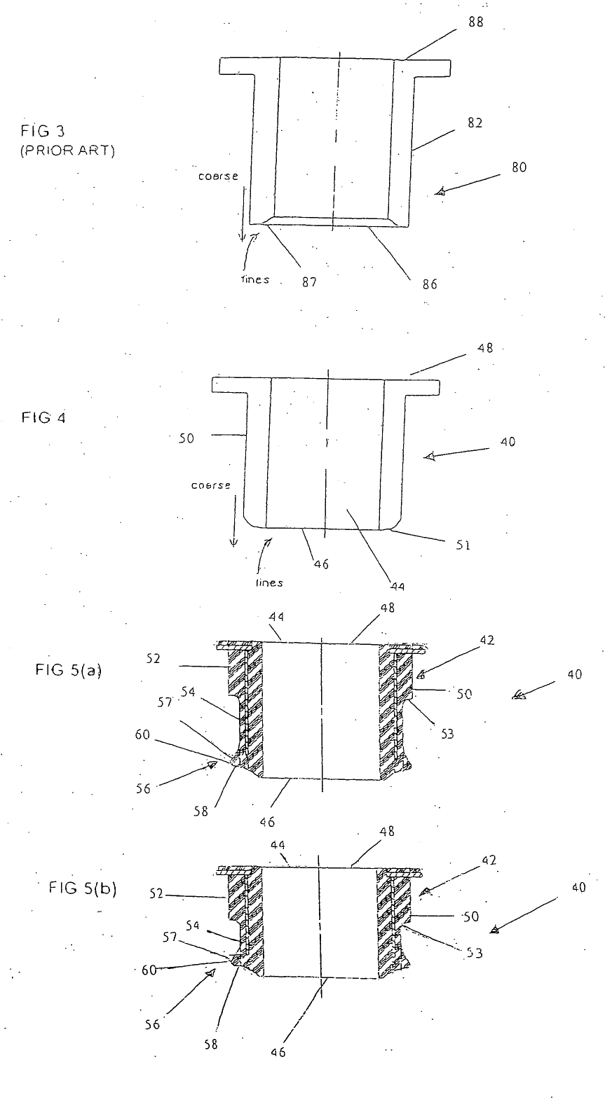

FIG. 3 is an axial cross sectional side elevation of a conventional vortex finder;

FIG. 4 is an axial cross sectional side elevation of a vortex finder according to one embodiment of the present invention;

FIGS. 5(a) and 5(b) are axial cross section side elevations of vortex finders according to another embodiment of the present invention;

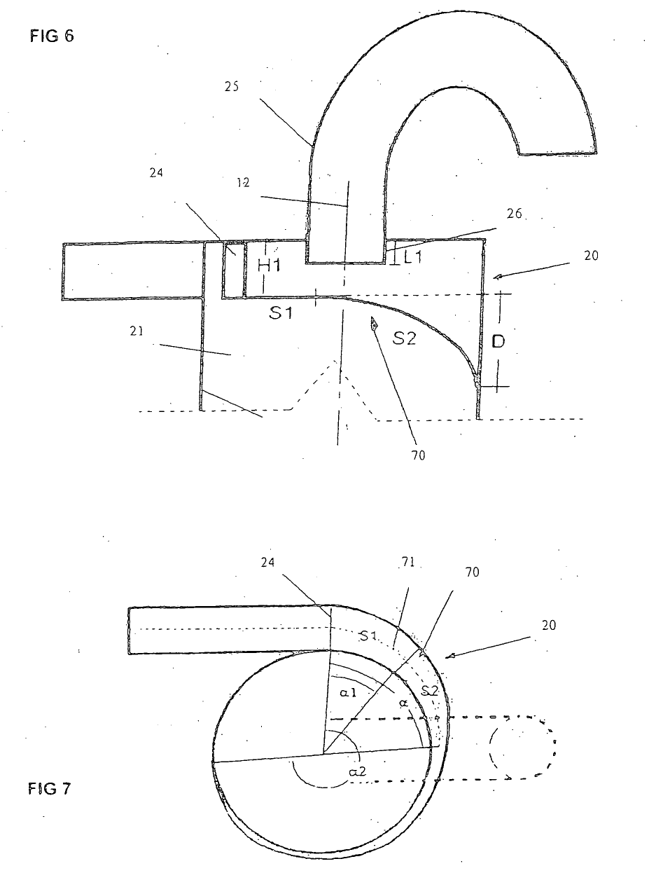

FIG. 6 is a schematic axial cross sectional view of an inlet head for a hydrocyclone which is particularly suited for use in the present invention; and

FIG. 7 is a plan view of the inlet head shown in FIG. 5.

Referring to FIG. 2, there is illustrated a cyclone 10, which in use, is normally orientated with its central axis 12 being disposed upright. The cyclone 10 includes an inlet head 20, having a feed chamber 21 therein with an inner side wall 22 and a top wall 23. An inlet port 24 provides for delivery of material to be separated to the feed chamber 21. An overflow outlet 25 is provided in the top wall 23 and a vortex finder 26 extends into the feed chamber 21. Downstream of the inlet head 20 is a separating section 30 which has a separating chamber 32 with a conically shaped inner wall 33. An under flow outlet or spigot 35 is provided at the end of the separating section 30.

A preferred form of inlet head is shown in FIGS. 6 and 7. The inlet head includes an inlet port 24 which is generally rectangular in cross section and has a height dimension H1 in the direction of the central axis. The feed inlet to the feed chamber 21 is generally tangential to the inner side wall 22. The vortex finder 26 extends into the feed chamber a distance L1 from the inner surface of the top wall.

The inlet head 20 includes a feed inlet zone 70 which extends from the inlet port 24. The inlet zone 70 is in the form of a volute having a volute axis 71 and includes a first sector S1 which is generally horizontally disposed and extends along the side wall for an angle α1 and a second sector S2 downstream of the first sector S1, the second sector extending around the side wall for an angle α2 and downwardly in the direction of the central axis for a distance D for every 90° of progression around the side wall.

As shown the distance from the volute axis 71 to the central axis 12 progressively decreases from the inlet port 24. Furthermore, the length L1 of the vortex finder is less than dimension H1. It has been found that the fraction F of L1 to H1 can range from 0 to 0.95. Desirably D is from 0.25 H1 to H1 for every 90° progression of the volute. Furthermore the variation of the generatrix radius of the volute S1 plus S2 with the angle α must continuously decrease; that is it does not contain any singular points and preferably is a straight line or curve. The angle α2 preferably ranges from 200° to 380°.

The vortex finder of the present invention is particularly suitable for use with an inlet head of the type described above and including the type referred to earlier as the CAVEX inlet head.

FIG. 3 illustrates a conventional vortex finder. The vortex finder 80 includes a main body 82 which is generally cylindrical and has an inlet 86 at one end and an outlet 88 at the other. The end face of the inlet has an arcuate surface 87 which tapers inwardly. Fluid entering the inlet head contains a mixture of coarse particulates and finer particulates. Part of this mixture forms a boundary layer fluid flow along the outer side surface of the vortex finder. Because the free end of the vortex finder terminates abruptly the boundary layer fluid flow tends to continue beyond the free end and interfere with the overflow stream thereby causing integration of some coarse material into the overflow stream.

FIG. 4 illustrates a vortex finder according to one embodiment of the present invention. The vortex finder 40 includes a main body 42 having a passage 44 extending there through one end of the passage being an inlet 46 and the other end an outlet 48. The main body 42 includes a sidewall 50 and an end face 51 which is curved. The curved configuration improves hydrocyclone performance by influencing the behaviour of the slurry in the boundary layer adjacent the vortex finder external surface. In FIG. 4 the end face is configured so as to extend beyond the free edge of the side wall surface the end face curving inwardly towards the inner side wall surface. This arrangement causes separation of the boundary layer fluid flow in the region of the free edge face of the side wall surface thereby providing effective separation of the overflow stream and the boundary layer stream.

Referring to FIGS. 5(a) and 5(b), the vortex finder 40 according to a further embodiment of the present invention includes a main body 42 having a passage 44 extending there through one end of the passage being an inlet 46 and the other end an outlet 48. The main body 42 includes a sidewall 50 which includes a first section 52, a second section 54 and a flange 56. The first section 52 is adjacent the outlet 48 and the second section 54 extends from the first section 52 towards the inlet 46. The second section 54 is of smaller cross sectional dimension than the first section 52 so as to form a shoulder 53 at the junction of the first and second sections. The flange 56 includes sidewall sections 57 and 58 extending from the second section 54 and the inlet 46 respectably and terminating at a distal portion 60. The side wall sections 57 and 58 are curved or arcuate in configuration with side wall section 58 forming an end face of the main body. The vortex finder illustrated in FIG. 5(b) is substantially the same as that shown in FIG. 5(a) except the length of the second section 54 is shorter. These re-configured vortex finders improve hydrocyclone performance by interrupting the behaviour of the slurry in the boundary layer adjacent the vortex finder. In the embodiment of FIGS. 5a and 5b, the configuration of the flange enhances the separation boundary layer fluid flow and the overflow stream.

It has also been found that by using a vortex finder configuration of the type described above with reference to FIGS. 3 and 4 and particularly in combination with an inlet head as described with reference to FIGS. 5 and 6, that for a given size of hydrocyclone it is possible to increase the size of the inlet port, the vortex finder and the under flow outlet or spigot and be able to obtain equivalent cut sizes. Thus the overall throughput handling capacity of a hydrocyclone of given size can be increased.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Finally, it is to be understood that various alterations, modifications and/or additions may be incorporated into the various constructions and arrangements of parts without departing from the spirit or ambit of the invention.

1. An inlet head for a cyclone, the inlet head including a feed chamber therein having an inner side wall, a top or end wall at one end of the side wall, an open end at the other end of the side wall, the open end being of circular cross-section with a central axis, an inlet port adjacent the top or end wall for delivering an inlet stream of material to be separated to the feed chamber, an overflow outlet in the top or end wall which is coaxial with the central axis, a vortex finder extending into the feed chamber in the direction of the central axis through which an overflow stream of separated material passes to the overflow outlet, the vortex finder including a generally tubular body having a side wall with an outer side wall surface and a passageway which includes an inlet end and an outlet end the passageway extending through the body, the passageway having an inner side wall surface and an end face at the inlet end, the vortex finder having a flange extending from the outer side wall surface, the inlet port having a feed height dimension H1 in the direction of the central axis, said vortex finder extending into the feed chamber in the direction of the central axis at a distance L1 from the top or end wall, the distance L1 being less than the height dimension H1.

2. An inlet head according to claim 1 wherein the outer side wall surface of the vortex finder has a free edge and the end face may be generally convex in shape when viewed in axial cross section extending beyond the free edge of the outer side wall surface to the inner side wall surface.

3. An inlet head according to claim 2 wherein the flange is on the outer side wall section in the region of the end face, the flange including side sections extending from the side wall surface terminating at a distal portion.

4. An inlet head according to claim 3 wherein the side sections of the flange are curved with one forming the end face.

5. An inlet head according to claim 4 wherein the flange side sections are generally concave in shape when viewed in axial cross section.

6. An inlet head according to claim 5 wherein the outer side wall surface may include a first section remote from the free end portion and a second section between the first section and the free end portion the second section being of smaller cross sectional dimension than the first section.

7. An inlet head according to claim 1 including a feed inlet zone in the inner side wall of the feed chamber having an upstream end adjacent the inlet port and a downstream end, the feed inlet zone being in the form of a volute having a volute axis extending around the inner side wall and including a first sector in which the volute axis is generally at right angles to the central axis and a second sector in which the volute axis extends around the side wall generally in the direction of the central axis away from the end wall wherein the distance from the volute axis to the central axis decreases with the progression of the volute from the inlet port.

8. (canceled)

9. An inlet head according to claim 7 wherein the inlet port is generally rectangular in cross-section and the distance LI is less than 0.95 of the height dimension HI.

10. An inlet head according to claim 7 wherein the first sector progresses horizontally from the inlet port around the inner side wall for an angle al which ranges from 0° to 100°, and the second sector descends from the horizontal plane and extends in the direction of the central axis over a distance D ranging from 0.25×HI to 1×HI for every 90° of progress around the inner side wall.

11. (canceled)

12. An inlet head for a cyclone, the inlet head including a feed chamber therein having an inner side wall, a top or end wall at one end of the side wall, an open end at the other end of the side wall, the open end being of circular cross-section with a central axis, an inlet port adjacent the top or end wall for delivering an inlet stream of material to be separated to the feed chamber, an overflow outlet in the top or end wall which is coaxial with the central axis, a feed inlet zone in the inner side wall of the feed chamber having an upstream end adjacent the inlet port and a downstream end, the feed inlet zone being in the form of a volute having a volute axis extending around the inner side wall and including a first sector in which the volute axis is generally at right angles to the central axis and a second sector in which the volute axis extends around the side wall generally in the direction of the central axis away from the end wall wherein the distance from the volute axis to the central axis decreases with the progression of the volute from the inlet port, a vortex finder extending into the feed chamber in the direction of the central axis through which an overflow stream of separated material passes to the overflow outlet, the vortex finder including a generally tubular body having a side wall with an outer side wall surface and a passageway extending through the body, the passageway having an inner side wall surface and a free end portion, and a flange extending from the outer side wall surface.

13. An inlet head according to claim 12 wherein the tubular body has an annular end face at the free end portion which is generally convex in shape when viewed in axial cross-section extending from the outer side wall surface to the inner side wall surface.

14. An inlet head according to claim 13 wherein the end face at least in part forms the flange.

15. An inlet head according to claim 12 wherein said flange includes side sections extending from the outer side wall surface terminating at a distal portion.

16. An inlet head according to claim 15 wherein the side sections of the flange are curved with one forming the end face of the vortex section.

17. An inlet head according to claim 16 wherein the flange side sections are generally concave in shape when viewed in axial cross section.

18. An inlet head according to claim 17 wherein the outer side wall surface includes a first section remote from the free end portion and a second section between the first section and the free end portion, the second section being of smaller cross sectional dimension than the first section.

19. An inlet head according to claim 18 wherein the inlet port has a feed height dimension H1 in the direction of the central axis and the vortex finder extends into the feed chamber in the direction of the central axis at a distance L1 from the top or end wall, the distance L1 being less than the height dimension H1.

20. An inlet head according to claim 17 wherein the inlet port is generally rectangular in cross-section and the distance L1 is less than 0.95 of the height dimension H1.

21. An inlet head according to claim 20 wherein the first sector progresses horizontally from the inlet port around the inner side wall for an angle α1 which ranges from 0° to 100°, and the second sector descends from the horizontal plane and extends in the direction of the central axis over a distance D ranging from 0.25×H1 to 1×H1 for every 90° of progress around the inner side wall.

22. A hydrocyclone which includes an inlet head according to claim 12, a separating section having an inner side wall which tapers inwardly away from the inlet head, and an underflow outlet at the other end of the separating section remote from the inlet head, the overflow outlet and underflow outlet being generally axially aligned.
